(19) United States
(12) Patent Application Publication
(10) Pub. No.: US 2018/0199399 A1
(43) Pub. Date: Jul. 12, 2018

(54) Control System Circuitry for Appliances

(71) Applicant: NuWave, LLC, Libertyville, IL (US)

(72) Inventor: Jung S. Moon, Long Grove, IL (US)

(21) Appl. No.: 15/867,096

(22) Filed: Jan. 10, 2018

Related U.S. Application Data
(60) Provisional application No. 62/444,456, filed on Jan. 10, 2017.

(51) Int. Cl. H05B 1/02

(52) U.S. Cl. CPC H05B 1/0205; H01H 85/0241; H05B 1/0261

(57) ABSTRACT

A control system for appliances, such as an electric grill, air fryer, convection oven, induction cooker (e.g., wok), coffeemaker, etc. The control system comprises circuitry for controlling operation of the appliance, including a first safety component in the circuitry for stopping a function, such as heating a liquid or an element, at a threshold parameter, such as a maximum temperature, and a second safety component in the circuitry for stopping the function of the first safety component at the threshold parameter. The first and second safety components, preferably switches or fuses, are connected in series to establish a redundant safety mechanism.

### RELATED APPLICATION

The present disclosure claims the filing priority of U.S. Provisional Application No. 62/444,456, titled “Control System Circuitry For Appliances” filed on Jan. 10, 2017. The '456 application is hereby incorporated by reference.

### TECHNICAL FIELD OF THE INVENTION

The present invention relates to control system circuitry for household appliances. Specifically, the invention relates to safety control circuitry which prevents overheating due to a component failure.

### BACKGROUND OF THE INVENTION

It is not uncommon for manufactured electronic components to fail in use. Typically, the consequences of failure are not severe. However, with some electronic components, failure may have far more significant costs, including injury to a user.

Practically speaking, eventually all components will fail. Most electronic components far outlast the devices into which they are installed. Accordingly, manufacturing defects can account for the majority of early component failures.

Until the invention of the present application, these and other problems in the prior art went either unnoticed or unsolved by those skilled in the art. The present invention provides control system circuitry which is capable of performing multiple functions with associated electronic devices/appliances without sacrificing functionality, safety or affordability.

### SUMMARY OF THE INVENTION

There is disclosed herein an improved safety control system for electronic devices which avoids the disadvantages of prior systems while affording additional operating advantages.

Generally speaking, the control system is designed for use in household appliances with heating elements, such as an air fryer, electric grill, convection oven, induction cooker (e.g., wok), coffeemaker, and the like. The control system comprises circuitry which is typically used for controlling operation of the appliance, but also includes a redundant safety mechanism in the circuitry for stopping an operation function, such as heating a liquid or an element at a threshold parameter, such as a maximum temperature.

The redundant safety mechanism comprises first and second safety components in the circuitry for stopping the function of a component, such as a heating element, at the threshold parameter. The first and second safety components, preferably switches or fuses, are connected in series to establish the redundant safety mechanism.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic of an embodiment of the proposed control circuitry.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

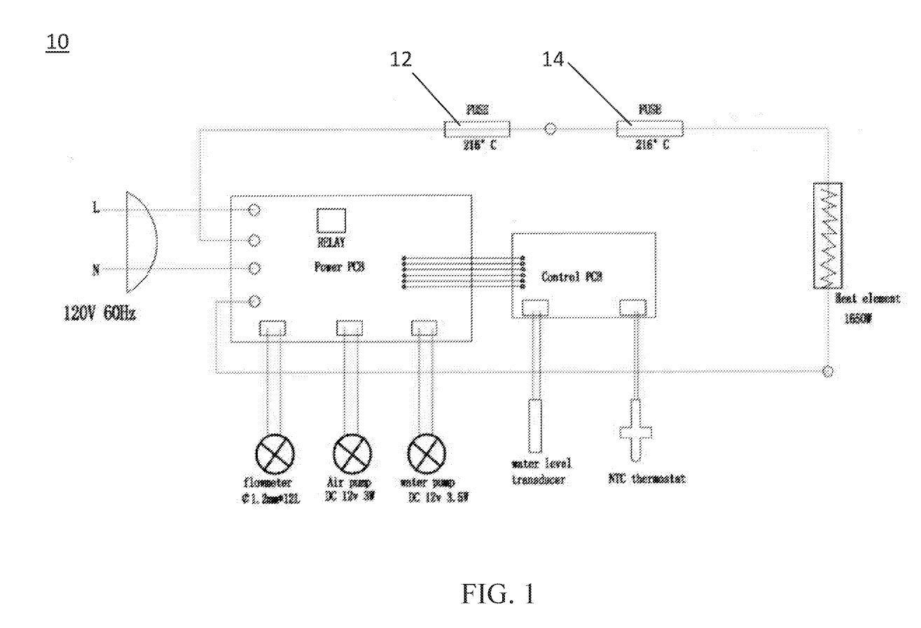

Referring to FIG. 1, there is illustrated control circuitry 10. The particular illustrated circuitry 10 is for appliances. Specifically, the control system circuitry 10 is for operation of appliances with heating elements, such as an electric grill, an air fryer, a convection oven, an induction cooker (e.g., wok), a coffeemaker, and the like. Most specifically, the control system comprises circuitry for controlling operation of the appliance and includes a first safety component 12 in the circuitry 10 for stopping a function, such as the heating of a liquid or of an element, at a threshold parameter, such as a maximum temperature, and a second safety component 14 in the circuitry 10 for stopping the same function as the first safety component at a threshold parameter. The threshold parameter of the second safety component 14 may be the same as the first component 12, or slightly greater. This configuration would insure that the first safety component 12 would act before the second component 14, except in the situation of a failure of the first component 12.

As shown in FIG. 1, the first and second safety components, 12 and 14, are preferably switches or fuses. As illustrated, the fuses 12, 14 are connected in series to establish a redundant safety mechanism. Should the first fuse 12 fail, the circuitry 10 would overheat and could pose a danger for some appliances. However, with the second fuse 14 placed in series, the heating function of the appliance would still be stopped upon reaching the threshold temperature.

The disclosures of copending U.S. patent application Ser. Nos. 15/866,159, 15/867,012, and 15/866,056 are hereby incorporated by reference.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A control system for appliances, the control system comprising:
circuitry for controlling operation of an appliance;
a first safety component in the circuitry for stopping a function at a threshold parameter;
a second safety component in the circuitry for stopping the function of the first safety component at a threshold parameter, wherein the first and second safety components are connected in series.

2. The control system of claim 1, wherein the first and second safety components are selected from switches and fuses and the threshold parameter is a predetermined temperature.

3. The control system of claim 1, wherein the control system is positioned within an appliance having a heating element.

4. The control system of claim 3, wherein the control system is positioned within an appliance selected from a coffeemaker, an induction wok, a deep fryer, an air fryer, and an electric griller.

5. The control system of claim 1, wherein the threshold parameter of the first safety component is a predetermined temperature and the threshold parameter of the second safety component is a predetermined temperature.

6. The control system of claim 5, wherein the predetermined temperature of the second safety component is higher than the predetermined temperature of the first safety component.

7. The control system of claim 5, wherein the predetermined temperature of the second component is the same as the predetermined temperature of the first safety component.

8. Control circuitry having a redundant safety mechanism comprised of at least two switches or fuses connected in series to prevent overheating.

9. Control circuitry of claim 8, wherein the circuitry is positioned within an appliance having a heating element.

10. Control circuitry of claim 9, wherein the circuitry is positioned within an appliance selected from a coffeemaker, an induction wok, a deep fryer, an air fryer, and an electric griller.

11. Control circuitry of claim 8, wherein each of the two switches or fuses have a threshold temperature and the threshold temperature of the second switch is higher than the threshold temperature of the first switch.

12. Control circuitry of claim 8, wherein each of the two switches or fuses has a threshold temperature and the threshold temperatures are the same.
